(19) United States
(12) Patent Application Publication
(10) Pub. No.: US 2014/0351725 A1
(43) Pub. Date: Nov. 27, 2014

(54) METHOD AND ELECTRONIC DEVICE FOR OPERATING OBJECT

(71) Applicant: Samsung Electronics Co., Ltd, Gyeonggi-do (KR)

(72) Inventors: Geon-Soo Kim, Gyeonggi-do (KR); Yong-Joon Jeon, Gyeonggi-do (KR)

(73) Assignee: Samsung Electronics Co., Ltd, Gyeonggi-do (KR)

(21) Appl. No.: 14/287,936

(22) Filed: May 27, 2014

(30) Foreign Application Priority Data
May 27, 2013 (KR) 10-2013-0059663

(51) Int. Cl. G06F 3/0488; G06F 3/0484; G06F 3/0481

(52) U.S. Cl. CPC G06F 3/04883; G06F 3/0481; G06F 3/04845
USPC 715/765

(57) ABSTRACT

A method of operating an electronic device includes sensing a gesture on a certain region of a touch screen; determining an edit region corresponding to the gesture; and editing at least one of a first region input in a handwriting type input mode and a region between the first region and a second region in the determined edit region.

### PRIORITY

The present application is related to and claims priority under 35 U.S.C. §119 to an application filed in the Korean Intellectual Property Office on May 27, 2013 and assigned Serial No. 10-2013-0059663, the contents of which are incorporated herein by reference.

### TECHNICAL FIELD

The present disclosure relates generally to a method and electronic device for operating an object.

### BACKGROUND

As electronic industry and a communication technology develop at alarming speed in recent years, new services based on data, voice and videos have been quickly developed. The rapid development in a micro electronic technology and computer software and hardware technologies becomes a base for an electronic device for processing more complex tasks, and the electronic device may eliminate a network restriction and have a more powerful functionality. Moreover, a user also needs an electronic device, in particular, a mobile terminal, such as a smart phone and wants a device that has a more powerful functionality and that is more flexible and simpler. As an information technology develops, an electronic device technology becomes intelligent, mobile and multifunctional.

As an electronic device develops, an electronic device input method is gradually moving from physical keys to virtual keys. The virtual key generally represents a soft key or a soft keyboard. Nevertheless, the electronic device input technology still needs improvement. For example, since an input mode is simple, a user experience is insufficient, and some electronic devices include a screen of significantly restricted size, there is a need for a more efficient input method.

### SUMMARY

To address the above-discussed deficiencies, it is a primary object to provide a method of operating an object in an electronic device having a touch screen, and an electronic device for operating an object.

Another object of the present disclosure is to provide a method and electronic device for operating an object for a convenient and efficient input method.

Another object of the present disclosure is to provide a method and electronic device for operating an object for intuitive screen editing according to a user intention.

According to an aspect of the present disclosure, a method of operating an object of an electronic device includes sensing a gesture on a certain region of a touch screen; and determining an edit region corresponding to the sensed gesture; and editing at least one of a first region input in a handwriting type input mode and a region between the first region and a second region in the edit region.

The gesture may indicate that at least a part of a finger or a touch pen performs any one of flicking, touch & drag, tab & hold, and multiple tab operations on the touch screen.

The gesture may include drawing a region binding symbol such as a reference line or a parenthesis on the touch screen.

The sensing of the gesture on the certain region of the touch screen may be performed in an eraser mode.

The sensing of the gesture on the certain region of the touch screen may be determined by using a closed curve that is made to have a certain size.

The method may further include deleting a region made by the closed curve if a diagonal line is drawn in the closed curve.

The editing of the edit region may be performed by confirmation through a popup window that contains at least one of text, image, and voice data.

The method may further include automatically deleting the edit region if the edit region has no data.

The gesture may include sensing multiple touches on the certain region of the touch screen; determining an edit region corresponding to the sensed multiple touches; and editing the edit region or data in the edit region according to a dragged direction if the multiple touches are dragged.

The editing of the data may include deleting data in the edit region or expanding the edit region according to the dragged direction.

The editing of the data may include expanding or reducing the size of data in the edit region according to the dragged direction.

The gesture may include sensing a reference line on a certain region of the touch screen; and determining an edit region corresponding to the sensed reference line; and editing the edit region or data in the edit region according to a dragged direction if the reference line is dragged.

The editing of the data may include deleting data in the edit region or expanding the edit region according to the dragged direction.

The editing of the data may include expanding or reducing the size of data in the edit region according to the dragged direction.

According to another aspect of the present disclosure, an electronic device includes a touch screen sensing a gesture; and a processor coupled to the touch screen, wherein the processor determines an edit region corresponding to the gesture and instructs to edit the determined edit region, and the processor edits at least one of a first region input in a handwriting type input mode and a region between the first region and a second region in the edit region.

According to another aspect of the present disclosure, an electronic device includes a touch screen sensing multiple touches; and a processor coupled to the touch screen, wherein the processor enters a handwriting type input mode, determines an edit region corresponding to the multiple touches, and instructs to edit the edit region or data in the edit region according to a dragged direction if the multiple touches are dragged.

The processor may instruct to delete data in the edit region or expand the edit region.

The processor may include a control unit that deletes the edit region and data in the edit region or expands the edit region.

The processor may include a control unit that expands or reduces the size of data in the edit region.

According to another aspect of the present disclosure, an electronic device includes a touch screen sensing a reference line; and a processor coupled to the touch screen, wherein the processor enters a handwriting type input mode, determines an edit region corresponding to the reference line, and instructs to edit the edit region or data in the edit region according to a dragged direction if the reference line is dragged.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates use of a touch pen in an electronic device according to various embodiments of the present disclosure;

FIGS. 2A to 2C illustrate a screen editing method using a gesture according to an embodiment of the present disclosure;

FIGS. 3A to 3C illustrate a screen editing method using a gesture according to an embodiment of the present disclosure;

FIGS. 4A to 4C illustrate a screen editing method using a gesture according to an embodiment of the present disclosure;

FIGS. 5A to 5C illustrate a screen editing method using a gesture according to an embodiment of the present disclosure;

FIGS. 6A to 6D illustrate a screen editing method using a gesture according to an embodiment of the present disclosure;

FIGS. 7A to 7C illustrate a screen editing method using a gesture according to an embodiment of the present disclosure;

FIGS. 8A to 8C illustrate a screen editing method using a gesture according to an embodiment of the present disclosure;

FIG. 9 illustrate a block diagram of an electronic device according to an embodiment of the present disclosure;

FIG. 10 is a flowchart illustrating a screen editing method according to an embodiment of the present disclosure;

FIG. 11 is a flowchart illustrating a screen editing method according to an embodiment of the present disclosure;

FIG. 12 is a flowchart illustrating a screen editing method according to an embodiment of the present disclosure;

FIG. 13 is a flowchart illustrating a screen editing method according to an embodiment of the present disclosure;

FIG. 14 is a flowchart illustrating a screen editing method according to an embodiment of the present disclosure;

FIG. 15 is a flowchart illustrating a screen editing method according to an embodiment of the present disclosure;

FIG. 16 is a flowchart illustrating a screen editing method according to an embodiment of the present disclosure; and

FIG. 17 is a flowchart illustrating a screen editing method according to an embodiment of the present disclosure.

### DETAILED DESCRIPTION

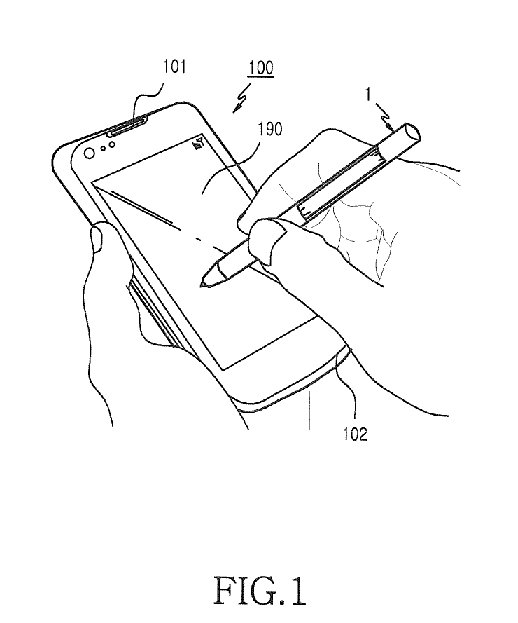

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Since the present disclosure may make various modifications and have several embodiments, particular embodiments will be illustrated in the drawings and described in the detailed description in detail. However, it is not intended to limit the present disclosure to particular embodiments but it should be understood that the present disclosure covers all modifications, equivalents, and replacements that fall within the scope and technology of the present disclosure.

While the terms first, second, and the like may be used for explaining various components, components should not be limited by such terms. The terms are used only for the purpose of distinguishing one component from another component. For example, a second component may be named as a first component without departing from the scope of the right of the present disclosure and likewise, the first component may be named as the second component.

When any component is referred to as being ‘connected’ to another component, it should be understood that the former can be ‘directly connected’ to the latter, or there may be another component in between. On the contrary, when any component is referred to as being ‘directly connected’ to another component, it should be understood that there may be no other component in between.

The terms used herein are used just to describe specific embodiments and are not intended to limit the present disclosure. The terms of a singular form may include plural forms unless being used as explicitly different meaning on the context. It should be understood that the term like “comprises”, “includes”, or “has” is herein intended to designate that there is a feature, a numeral, a step, an operation, a component, a part or their combination described in the specification and do not exclude one or more other features, numerals, steps, operations, components, parts or their combinations.

The operation principle of the present disclosure will be described in detail with reference the accompanying drawings. When describing the present disclosure, detailed descriptions related to well-known functions or configurations will be ruled out in order not to unnecessarily obscure subject matters of the present disclosure. In addition, since the terms are defined in consideration of functions in the present disclosure, they may vary depending on an operator intention or practice. Therefore, the definition needs to be made based on details in various embodiments of the present disclosure.

A method of operating an object of an electronic device according to various embodiments of the present disclosure will be described.

According to various embodiments, a method of operating an object of an electronic device may be a method of operating an object of an electronic document.

The electronic device is shown as a portable communication terminal including a touch screen in order to describe various embodiments of the present disclosure but the electronic device is not limited thereto. The electronic device may include various devices including a touch screen, for example, a Personal Digital Assistant (PDA), a laptop computer, a smart phone, a net book, a Mobile Internet Device (MID), Ultra Mobile PC (UMPC), a Tablet Personal Computer (tablet PC), a navigation device, and an MP3 player in the following description.

A gesture throughout the present disclosure means forming a touch pattern on a touch screen of the electronic device. A touch is made on a touch screen of the electronic device by a user finger or an external input unit such as a touch pen, and the gesture means forming a certain pattern of drag while maintaining the touch on the touch screen. In some cases, the gesture includes the release of the drag while maintaining the touch and the release of the touch. For example, the operation of writing or drawing a character or a figure on the touch screen may mean dragging along the contour of the character or the figure while touching the touch screen by using a user finger or an input unit such as a touch pen.

Moreover, throughout the present disclosure, the term ‘gesture’ may mean, for example, the motion of the hand of a user who controls the electronic device. Examples of the gesture described through the present disclosure may include tapping, touching & holding, double tapping dragging, panning, flicking, and dragging & dropping.

The term ‘tapping’ may be understood as being very quickly touched on a screen by using a finer or a stylus by a user. In other words, the term ‘tapping’ means when the time interval between touch-in and touch-out operations is very short. The touch-in operation means touching the screen by using the user finger or the stylus, and the touch-out operation means removing the finger or the stylus from the screen.

The term ‘touching and holding’ means maintaining a touch over a critical time interval after touching a screen by using a finger or a stylus by a user. That is, the term ‘touching and holding’ means when the time interval between a touch-in operation and a touch-out operation is equal to or longer than the critical time interval. If a touch input is maintained over the critical time interval, a video or audio feedback signal is provided to a user so that a user may determine whether the touch input is a tapping operation or a touching and holding operation.

The term ‘double tapping’ means quickly double touching a screen by using a finger or a stylus by a user.

The term ‘dragging’ means moving a finger or a stylus from one point to another point while maintaining a touch after a user touches one point on a screen by using the finger or stylus. The dragging moves an object or performs panning.

The term ‘panning’ means performing the dragging without selecting an object. Since the object is not selected while the panning is performed, a page in a screen moves or a group of objects instead of a single object move in a page if the panning is performed.

The term ‘flicking’ means quickly dragging by using a finger or stylus by a user. The dragging (or panning) and the flicking may be distinguished depending on whether a speed at which a finger or stylus moves is equal to or faster than a critical speed.

The term ‘dragging and dropping’ means removing a finger or stylus in order to drop an object where the finger or stylus is separated from the screen after a user drags the object to a desired location on the screen by using the finger or stylus.

A handwriting type input mode is used interchangeably with a handwriting recognition mode, a handwriting type recognition mode, or a handwriting input mode.

FIG. 1 illustrates use of a touch pen in an electronic device according to various embodiments of the present disclosure.

Referring to FIG. 1, an electronic device 100 may include a touch screen 190 on the front surface, an ear piece 101 may be arranged on the upper part of the electronic device 100 and a micro phone unit 102 may be arranged on the lower part of the electronic device 100. Moreover, the electronic device 100 may display characters, numbers, special symbols, and special characters on the touch screen 190. A user may input characters or figures by using his/her finger or an input unit such as a touch pen 1 in a handwriting type input mode. The handwriting type input mode may be provided when executing an application which enables a handwriting type input.

According to various embodiments, the touch screen 190 of the electronic device 100 may include a touch panel that recognizes a touch by using a human body such as a user finger or palm, and a pen touch panel for sensing an input by the touch pen 1.

The touch panel may be a capacitive or resistive touch panel for recognizing that data is input, when a user finger is in direct contact with the surface of the touch screen 190.

The pen touch panel may employ an electromagnetic guidance touch panel that may sense that the touch pen 1 is within a certain distance, before the touch pen 1 is in contact with the touch screen 190, or a space touch panel for a hovering input such as a sound wave touch panel or an infrared touch panel.

According to various embodiments, the touch panel that recognizes contact directly by using a user body may employ the capacitive touch panel and the pen touch panel may employ an electromagnetic guidance digitizer flat panel.

When a user takes the touch pen to a sensing region without contact with the touch screen 190, it is possible to prevent an input error due to a touch using a user palm by releasing the function of a human-body sensing touch panel. Thus, when the user uses the touch pen 1, a data input error due to a human body touch may be prevented even if a user palm is placed on the touch screen 190.

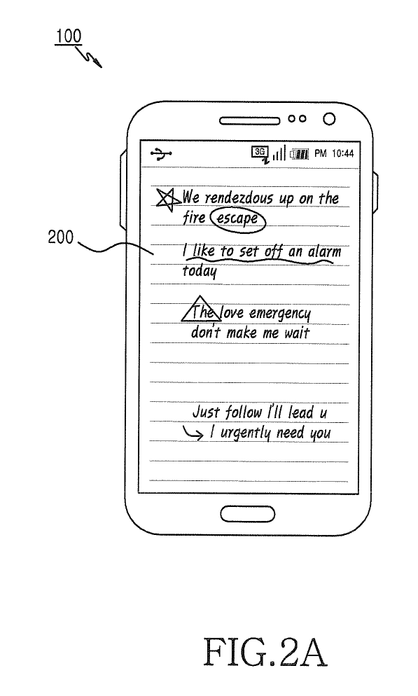

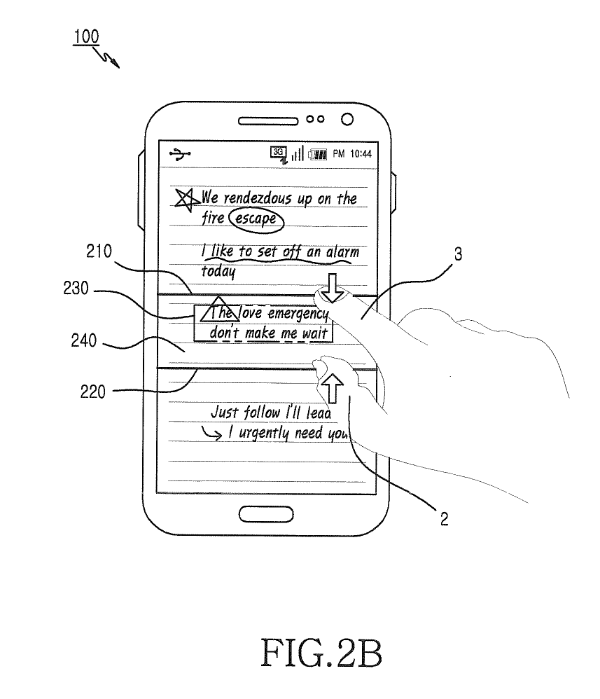

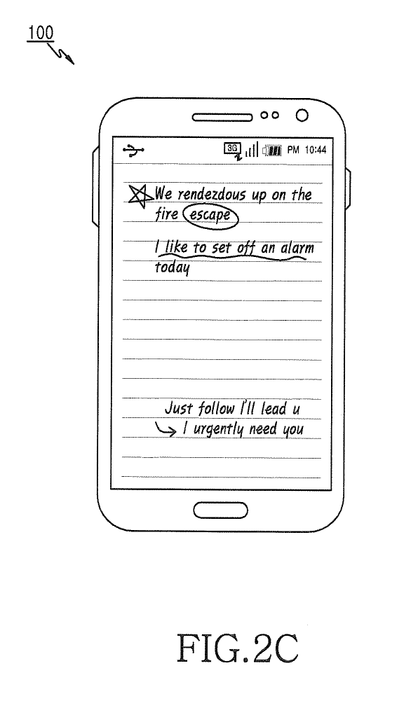

FIGS. 2A to 2C illustrate a screen editing method using a gesture according to an embodiment of the present disclosure.

Referring to FIGS. 2A to 2C, the electronic device 100 may display characters or figures on a touch screen 200. A user may input data by using his/her finger or an input unit such as a touch pen 1 in a handwriting type input mode. As shown in FIG. 2A, data may be characters, numbers, special symbols, and special characters, or the data may be image-type data.

According to various embodiments, the electronic device 100 may sense a gesture and delete data 230. Here, the gesture may be an operation that performs any one of flicking, touching & dragging, tab & hold, and multiple tab operations. As shown in FIG. 2B, it is possible to delete data 230 if a user drags thumb 2 and forefinger 3 inwardly by a certain distance (for example, 5 mm) while data 230 to be deleted is between thumb 2 and forefinger 3 and a user touches the touch screen 200 for a certain time (for example, two seconds) (as illustrated, for example, in FIG. 2C). In this case, it is also possible to display a popup window that checks whether to delete data 230. The popup window may be at least one of text, image and voice data.

If a user touches the touch screen 200 for a certain time, a first guide line 210 may appear in a horizontal direction around a touch point recognized by the thumb 2, and a second guide line 220 may appear in a horizontal direction around a touch point recognized by the forefinger 3. Moreover, the space between the first guide line 210 and the second guide line 220 may become an edit region 240. Pieces of data in the edit region 240 may be simultaneously deleted.

According to various embodiments, the guide lines may also become vertical guide lines depending on the touch locations of the thumb 2 and the forefinger 3. For example, when the slope of a line formed by connecting the touch point recognized by the thumb 2 to the touch point recognized by the forefinger 3 is detected and the slope is equal to or greater than a certain angle from a horizontal line, the guide lines may become vertical guide lines.

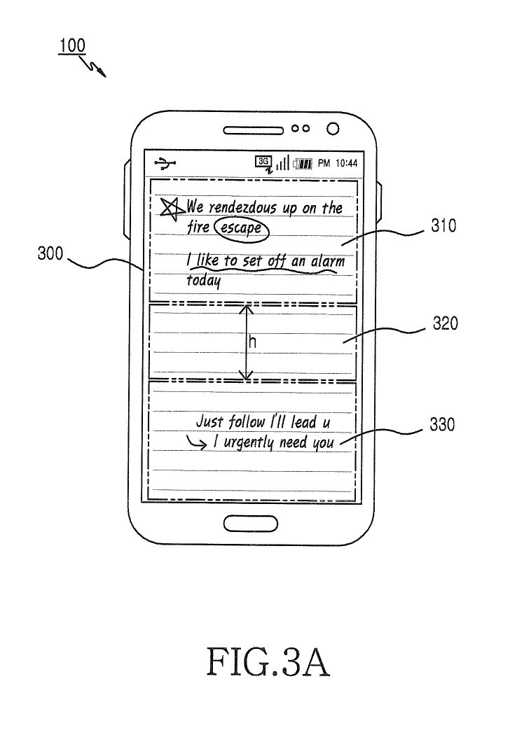

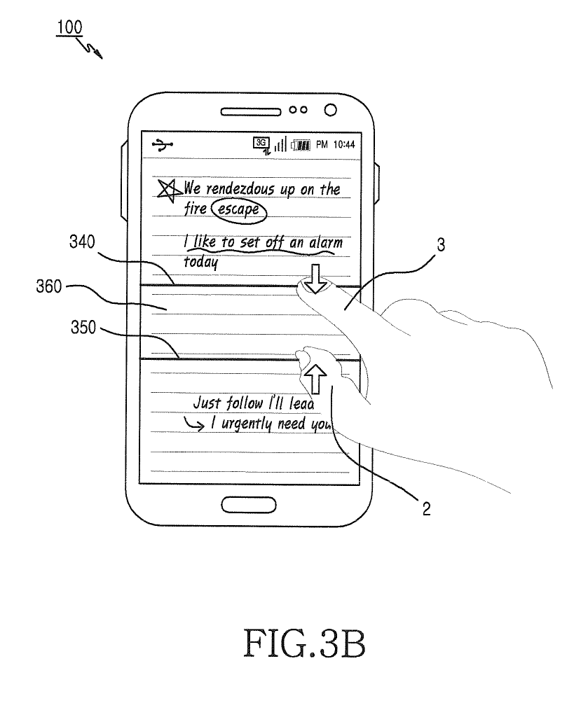

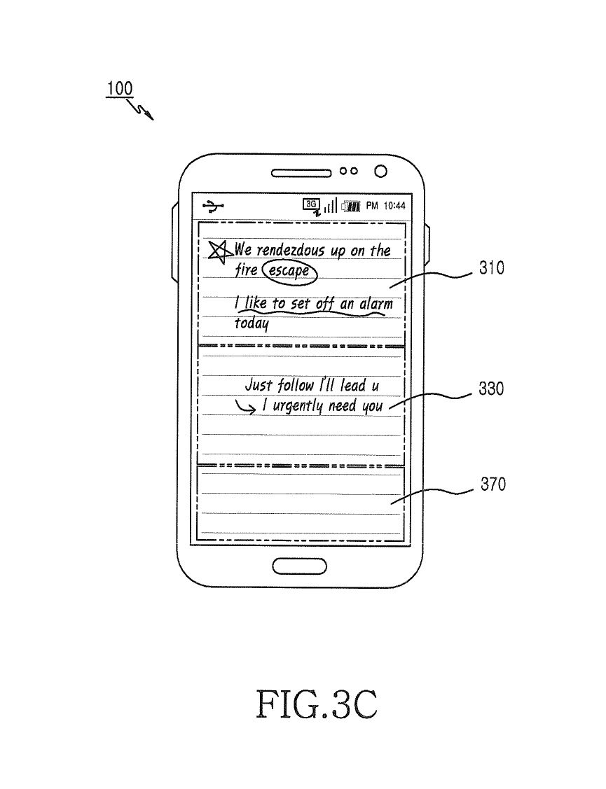

FIGS. 3A to 3C illustrate a screen editing method using a gesture according to an embodiment of the present disclosure.

Referring to FIGS. 3A to 3C, the electronic device 100 may display characters or figures on a touch screen 300. A user may input data by using his/her finger or an input unit such as a touch pen 1 in a handwriting type input mode. As shown in FIG. 3A, data may be characters, numbers, special symbols, and special characters, or the data may be image-type data.

According to various embodiments, the electronic device 100 may sense a gesture and delete an intermediate region 320. For example, the intermediate region 320 may be a data-free area or an area that a user wants to delete. As shown in FIG. 3A, the touch screen 300 may be divided into an upper region 310, an intermediate region 320, and a lower region 330. As shown in FIG. 3B, it is possible to delete the intermediate region 320 if a user drags thumb 2 and forefinger 3 inwardly by a certain distance (for example, 5 mm) after a user leaves the interval between the thumb 2 and the forefinger 3 by the vertical length h of the intermediate region 320 and touches the touch screen 300 for a certain time (for example, two seconds). In this case, it is also possible to display a popup window that checks whether to delete the intermediate 320.

For example, if a user touches the touch screen 300 for a certain time, a first guide line 340 may appear in a horizontal direction around a touch point recognized by the thumb 2, and a second guide line 350 may appear in a horizontal direction around a touch point recognized by the forefinger 3. Moreover, the space between the first guide line 340 and the second guide line 350 may become an edit region 360. If the edit region 360 is deleted, the upper region 310 and the lower region 330 may be connected and an empty region 370 may be further arranged on the lower end of the touch screen 300.

According to various embodiments, the guide lines may also become vertical guide lines depending on the touch locations of the thumb 2 and the forefinger 3. For example, when the slope of a line formed by connecting the touch point recognized by the thumb 2 to the touch point recognized by the forefinger 3 is detected and the slope is equal to or greater than a certain angle from a horizontal line, the guide lines may become vertical guide lines.

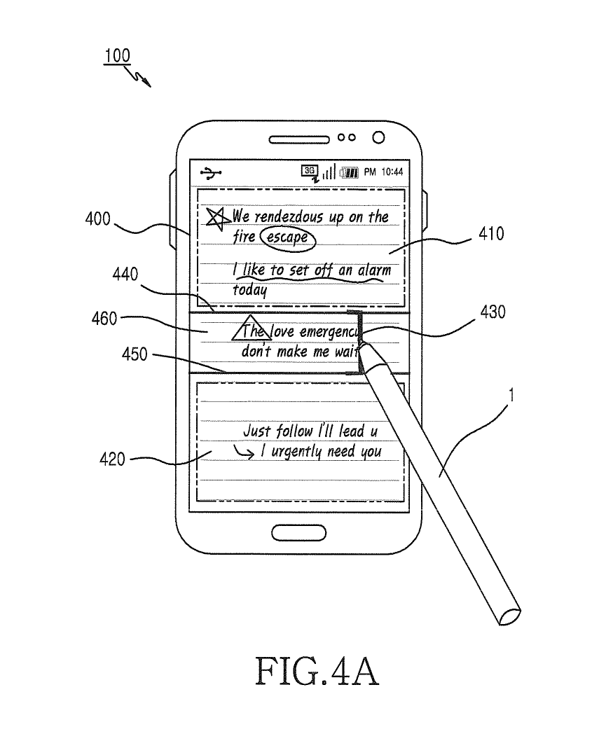

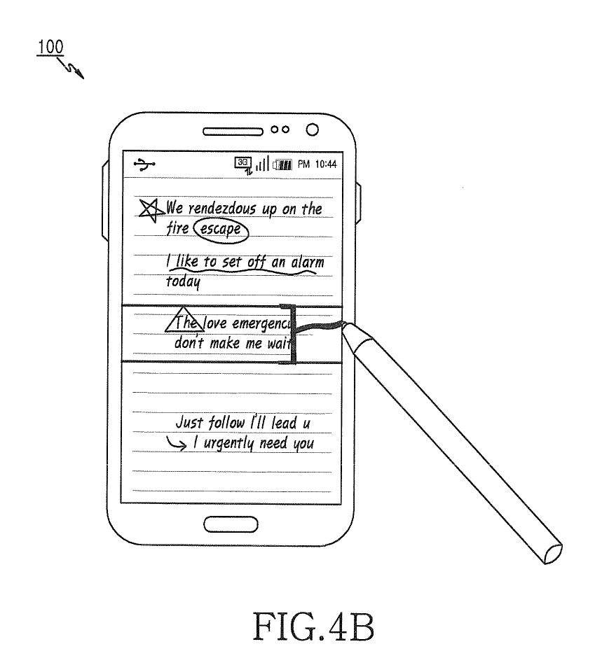

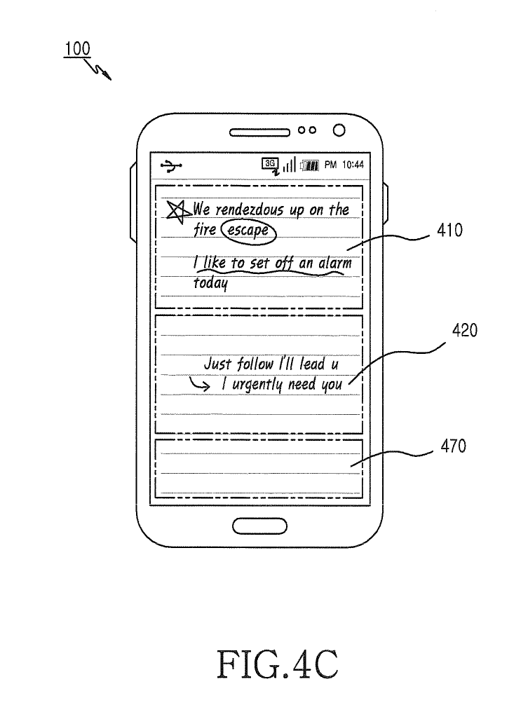

FIGS. 4A to 4C illustrate a screen editing method using a gesture according to an embodiment of the present disclosure.

Referring to FIGS. 4A to 4C, the electronic device 100 may sense a gesture and delete a certain region, according to various embodiments. In the case of an eraser mode in the handwriting type input mode, a user may input a gesture to a certain region of a touch screen 400. As shown in FIG. 4A, the gesture may include the operations of dragging and releasing an region binding mark 430 such as a parenthesis such as ‘]’ or ‘}’ from a certain region to a second certain region while touching an region binding mark 430 such as ‘]’ or ‘}’ by using a finger or an input unit such as a touch pen 1 (as illustrated, for example, in FIG. 4B). When drawing the region binding mark 430 such as a parenthesis, a first guide line 440 and a second guide line 450 may appear in a horizontal direction from both vertical ends of the mark 430. For example, the first guide line 440 and the second guide line 450 may divide the entire area into an upper region 410, an edit region 460, and a lower region 420 and select the edit region 460. According to various embodiments, if the edit region 460 is deleted, the upper region 410 and the lower region 420 may be connected and an empty region 470 having an area corresponding to the edit region 460 may be further arranged on the lower end of the touch screen 400.

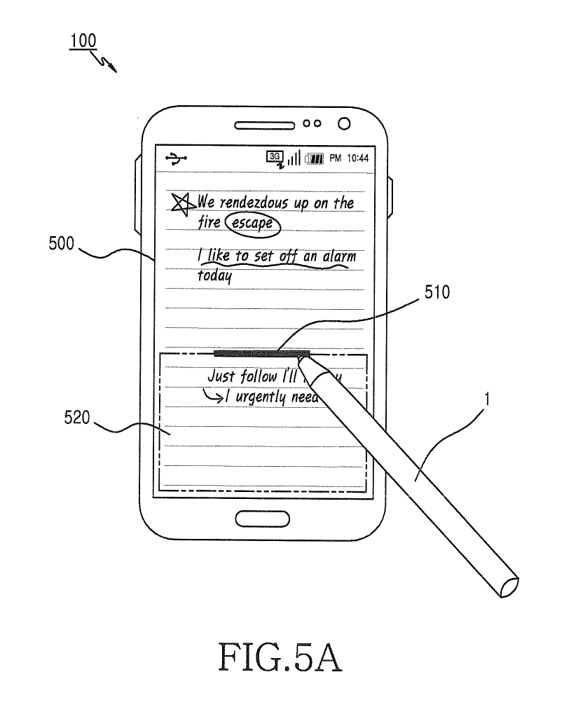

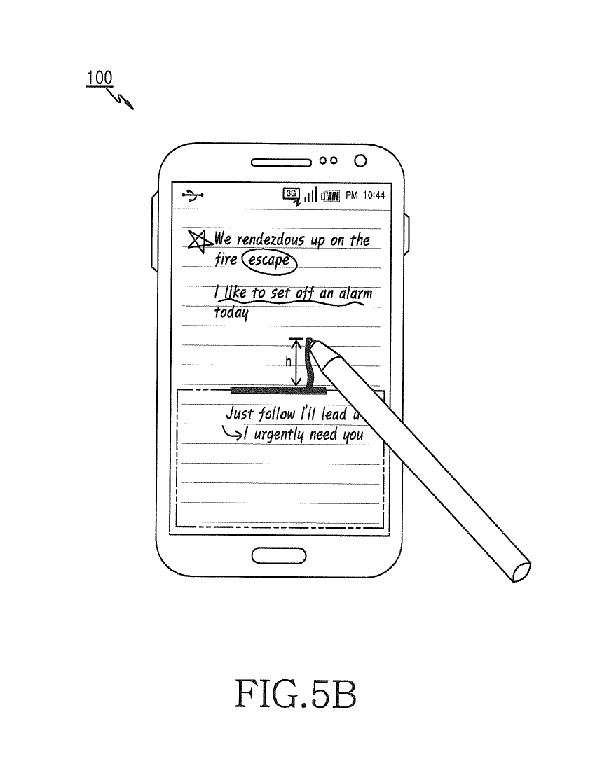

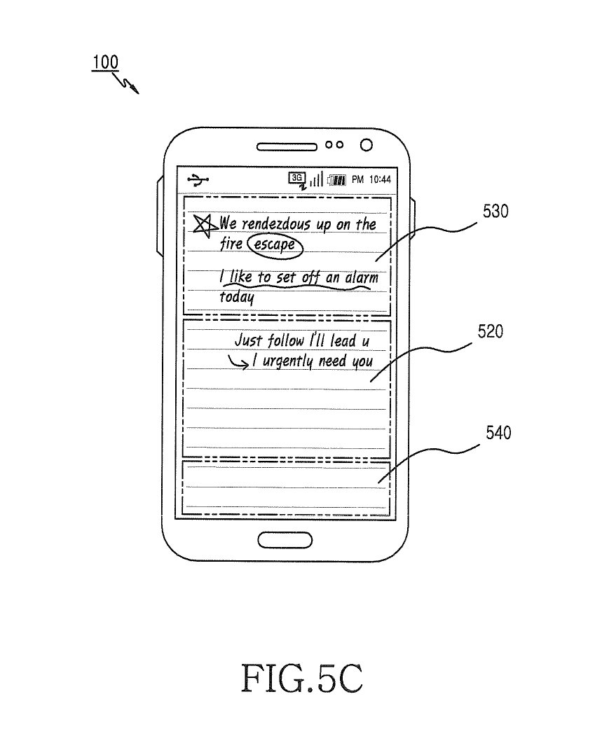

FIGS. 5A to 5C show a screen editing method using a gesture according to an embodiment of the present disclosure.

Referring to FIGS. 5A to 5C, the electronic device 100 may sense a gesture and delete a certain region. In the case of an eraser mode in the handwriting type input mode, a user may input a gesture to a certain region of the touch screen 500. As shown in FIG. 5A, the gesture may include the operations of drawing a reference line 510 having a certain length by using a finger or an input unit such as a touch pen 1 and of dragging up or down and releasing the reference line 510 while touching the reference line 510. When drawing the reference line 510, it is possible to select an edit region 520 corresponding to a lower part of the touch screen 500 from an extension line extended in a length direction of the reference line 510 if the reference line 510 has a certain length (as illustrated, for example, in FIG. 5B). Moreover, the edit region 520 may move up by the dragging distance h of the reference line 510.

For example, the edit region 520 may be connected to the upper region 530 and since the edit region 520 moves by the distance h, an empty region 540 may be further arranged on the lower part of the touch screen 500 (as illustrated, for example, in FIG. 5C).

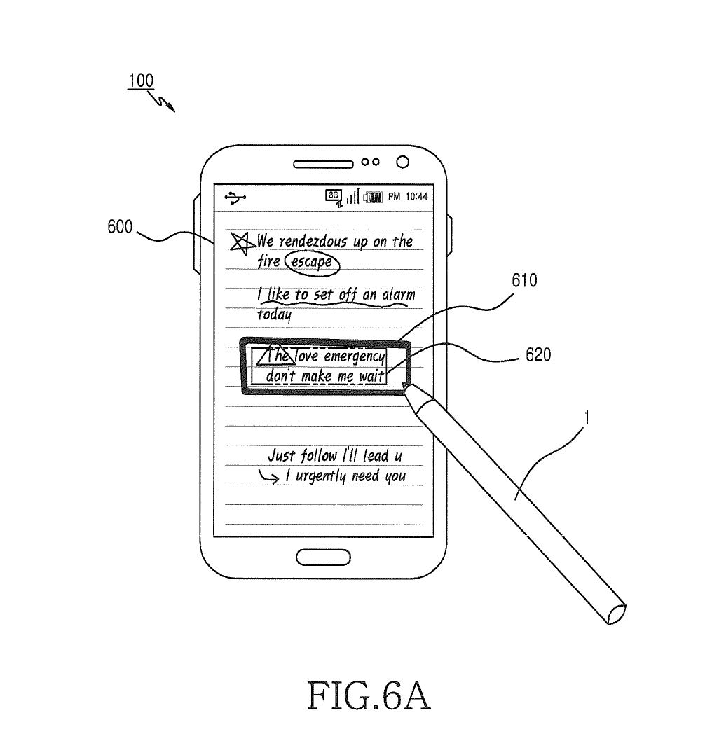

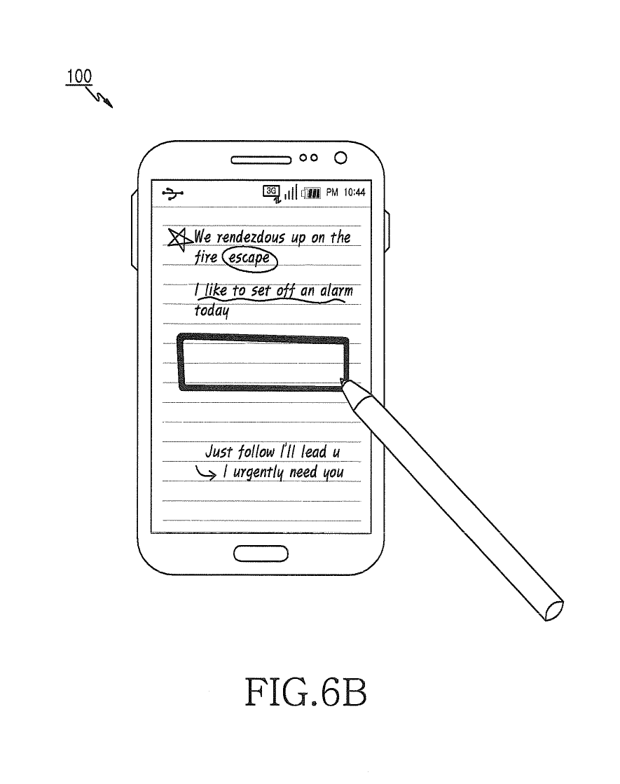

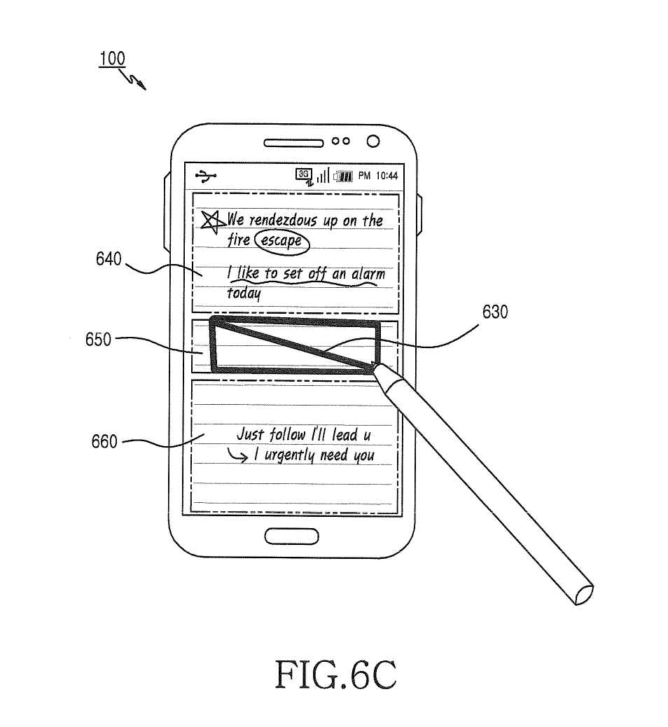

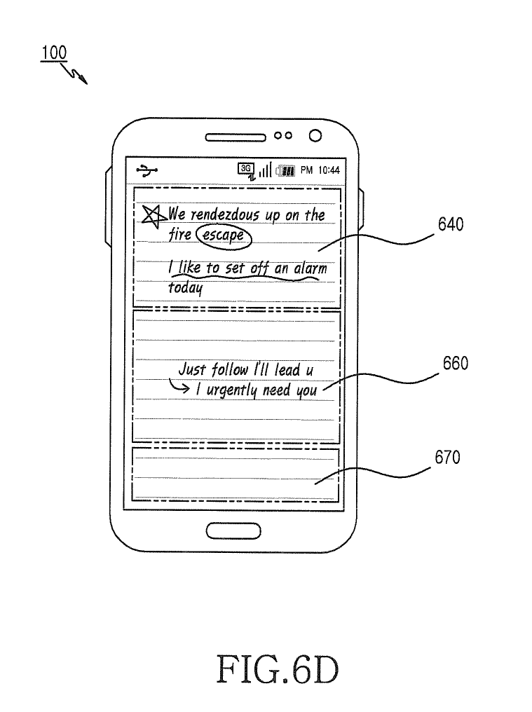

FIGS. 6A to 6C illustrate a screen editing method using a gesture according to an embodiment of the present disclosure.

Referring to FIGS. 6A to 6C, the electronic device 100 may sense a gesture and delete a certain region. In the case of an eraser mode in the handwriting type input mode, a user may input a gesture to a certain region of a touch screen 600. As shown in FIG. 6A, the gesture may include the operation of drawing a closed curve having a certain size by using a finger or an input unit such as a touch pen 1. Moreover, it may be determined that it is possible to create the closed curve 610 only if including at least one screen edge part. In this case, it is possible to delete data 620 in the closed curve 610 (as illustrated, for example, in FIG. 6B).

According to various embodiments, if drawing a continuous line having a certain length while drawing the closed curve, a guide line is created and thus may help draw the closed curve 610. It may be predetermined to include one or more surfaces of the closed curve 610. Moreover, a popup window that checks whether to delete the data 620 may also appear.

According to various embodiments, if the data 620 is deleted and then a diagonal line 630 is drawn in the closed curve 610 as shown in FIG. 6C, it is possible to delete an edit region 650 corresponding to the closed curve 610. The edit region 650 may be set according to the height of the closed curve 610. The lower region 660 of the touch screen 600 may be connected to the upper region 640 and an empty region 670 may be further arranged on the lower end of the touch screen 600 (as illustrated, for example, in FIG. 6D).

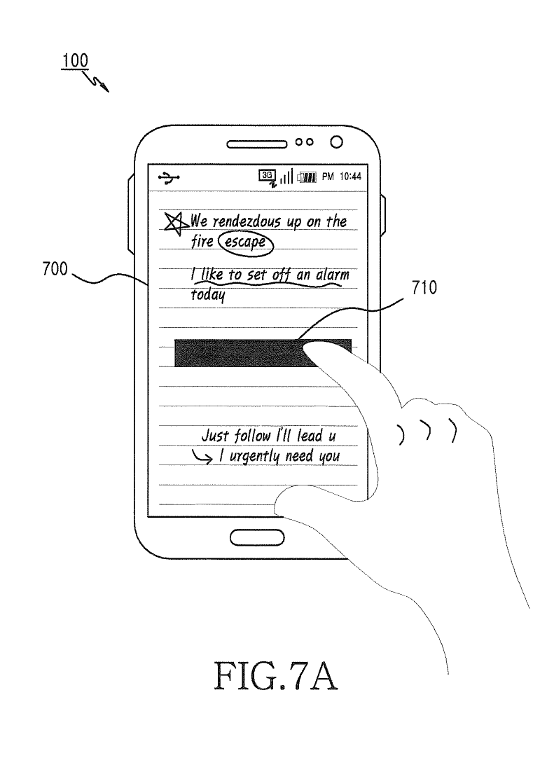

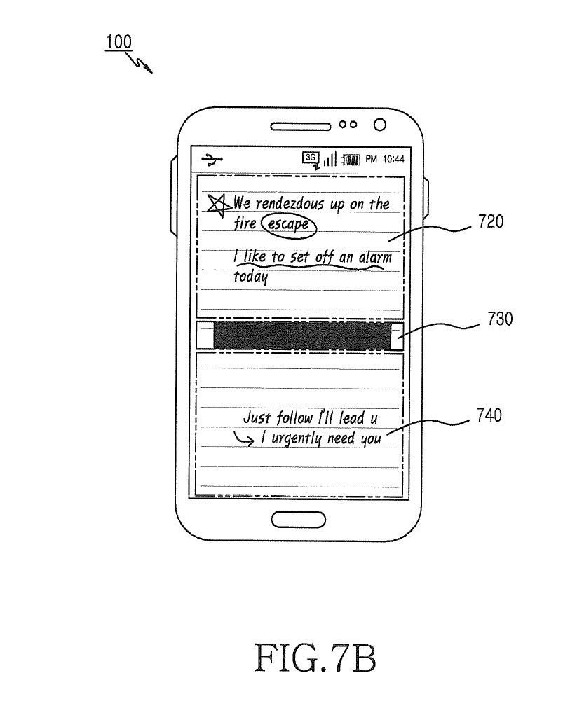

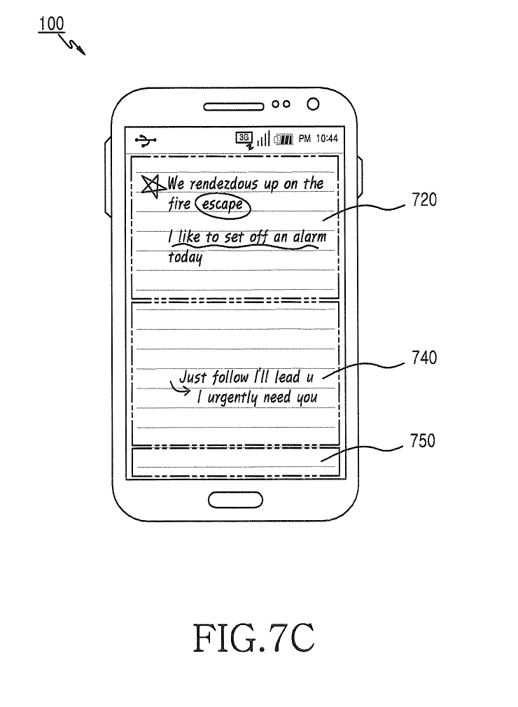

FIGS. 7A to 7C illustrate a screen editing method using a gesture according to an embodiment of the present disclosure.

Referring to FIGS. 7A to 7C, the electronic device 100 may sense a gesture and delete a certain region. In the case of an eraser mode in the handwriting type input mode, a user may input a gesture to a certain region of a touch screen 700. As shown in FIG. 7A, the gesture may include the operation of dragging a finger from a certain region to a second region while touching a screen by using at least a part of a finger. For example, if the area of a region 710 touched by at least a part of a finger touches is wider than a preset area, it may be recognized that a deleting operation is intended. In this case, it is possible to delete an edit region 730 corresponding to the touch region 710 as shown in FIG. 7B. A lower region 740 of the touch screen 700 may be connected to an upper region 720 and an empty region 750 corresponding to the area of the deleted edit region 730 may be further arranged on the lower part of the touch screen 700 (as illustrated, for example, in FIG. 7C).

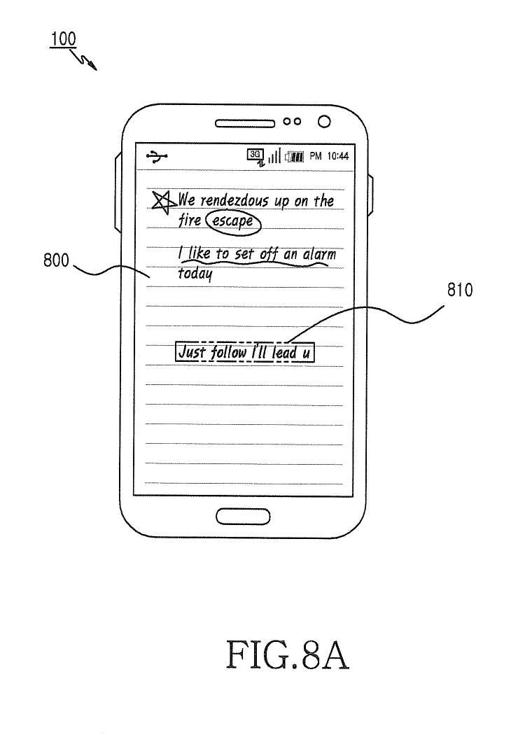

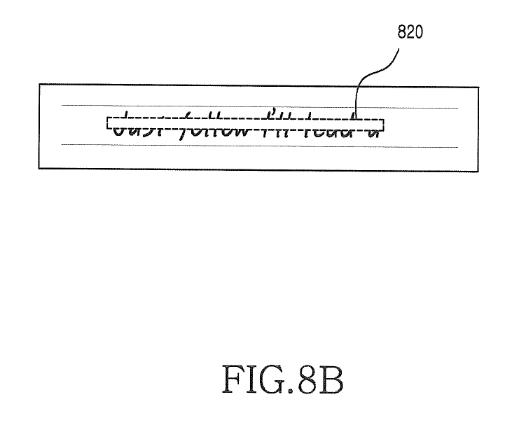

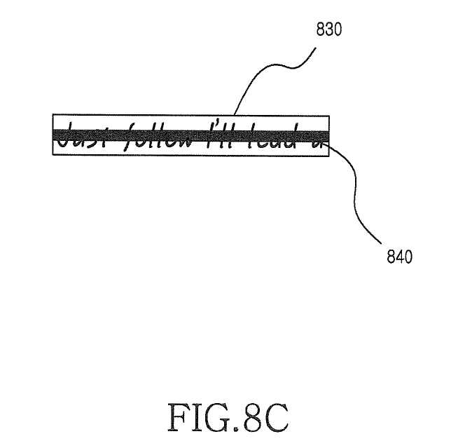

FIGS. 8A to 8C show a screen editing method using a gesture according to an embodiment of the present disclosure.

Referring to FIGS. 8A to 8C, the electronic device 100 may sense a gesture and delete at least a portion 820 of data 810. In the case of an eraser mode in the handwriting type input mode, a user may drag and delete at least a portion 820 of the data 810 (as illustrated, for example, in FIG. 8B). According to various embodiments, the electronic device 100 may detect the area 840 of at least a portion 820 of the deleted data 810 and compare the area 840 with a reference area. If a ratio of the area 840 of at least a portion 820 of the deleted data 810 to the recognition area 830 of the entire data 810 is equal to or greater than a certain value, it may be recognized that a deleting operation is intended and thus it is possible to delete the rest of the data 810.

According to various embodiments, the data 910 displayed on the touch screen 800 may be read by using an optical character reader (OCR) module. If a portion 820 of the data 810 is deleted, characters are not read by using the OCT module and a processor may instruct to delete all the data 810.

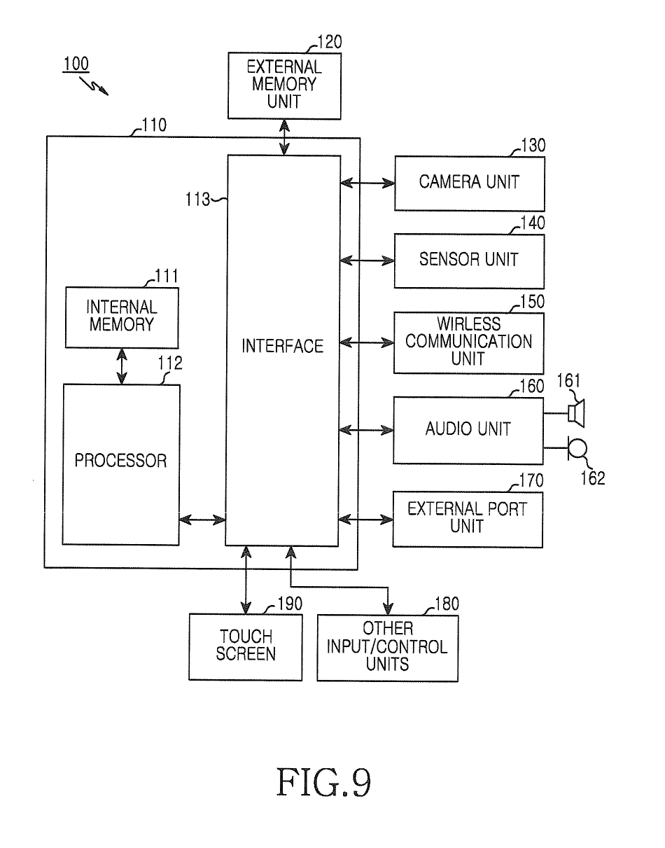

FIG. 9 illustrates a block diagram of an electronic device according to an embodiment of the present disclosure.

Referring to FIG. 9, an electronic device 100 may be a device such as a mobile phone, a media player, a tablet computer, a handheld computer or a PDA. Moreover, the electronic device 100 may be any portable terminal that includes a device having the functions of two or more of these devices.

The electronic device 100 includes a host unit 110, an external memory unit 120, a camera unit 130, a sensor unit 140, a wireless communication unit 150, an audio unit 160, an external port unit 170, a touch screen unit 190, and other input/control units 180. Moreover, each of the external memory unit 120 and the external port unit 170 may be in plural.

The host unit 110 includes an internal memory 111, one or more processors 112 and an interface 113. The internal memory 111, the one or more processors 112 and the interface 113 may be separate components or configured in one or more integrated circuits.

The processor 112 executes several software programs, performs several functions for the electronic device 100, and performs processing and control for voice, visual, and data communication. Moreover, in addition to these typical functions, the processor 112 executes a software module that is stored in the internal memory 111 or the external memory unit 120, and performs several functions corresponding to the module.

For example, the processor 112 is linked to software modules stored in the internal memory 111 or the external memory unit 120 and may perform methods according to various embodiments of the present disclosure. Moreover, the processor 112 may include one or more data processors, an image processor, or a codec. Furthermore, the electronic device 100 may also configure the data processors, the image processor or the codec separately.

The interface 113 may connect the several units of the electronic device 100 to the host unit 110.

The camera unit 130 may perform camera functions such as recording pictures and video clips. The camera unit 130 may include a charged coupled device (CCD) or a complementary metal-oxide semiconductor (CMOS).

Moreover, the camera unit 130 may change hardware aspects according to a camera program which the processor 112 executes. For example, according to the camera program, the camera unit 130 may move lens or adjust the number of irises.

The various components of the electronic device 100 may be connected through one or more communication buses (without reference numeral) or an electrical connection unit (without reference numeral).

The sensor unit 140 includes a motion sensor, a photo sensor, a temperature sensor, etc. and enables several functions. For example, the motion sensor may sense the motion of the electronic device 100 and the photo sensor may sense ambient light.

The wireless communication unit 150 enables wireless communication and may include wireless frequency transceiver and an optical (e.g., infrared) transceiver. The wireless communication unit 150 may be designed to operate according to a communication network. That is, it may operate through one of Global System for Mobile Communication (GSM), Enhanced Data GSM Environment (EDGE), Code Division Multiple Access (CDMA), W-Code Division Multiple Access (W-CDMA), Long Term Evolution (LTE), Orthogonal Frequency Division Multiple Access (OFDMA), Wireless Fidelity (Wi-Fi), WiMax and/or Bluetooth networks.

The audio unit 160 is connected to a speaker 161 and a microphone 162 and may be responsible for the input and output of audio such as voice recognition, voice copy, digital recording and call functions. Moreover, the audio unit 160 may receive a data signal from the host unit 110, convert the received data signal into an electrical signal, and output the electrical signal through the speaker 161.

The speaker 161 may convert and output the electrical signal into an audible frequency band, be arranged on the rear surface of the electronic device 100, and include a flexible film speaker that is formed by attaching at least one piezoelectric unit to one vibration film.

The microphone 162 converts a sound wave delivered from a human being or other sound sources into an electrical signal. Moreover, the audio unit 160 may receive the electrical signal from the microphone 162, convert the received electrical signal into an audio data signal, and transmit the audio data signal to the host unit 110. The audio unit 160 may include an earphone, a head phone or a head set that may be attached and detached to and from the electronic device 100.

The external port unit 170 may connect the electronic device 100 to another electronic device directly or indirectly through a network (e.g., internet, intranet, wireless LAN, etc.).

The touch screen 190 may provide an input and output interface between the electronic device 100 and a user. For example, the touch screen 190 may employ a touch sensing technology, deliver a user touch input to the host unit 110 and show visual information provided from the host unit 110, such as a text, a graphic, a video, etc. to the user. Moreover, the touch screen 190 may further employ any multi-touch sensing technology that includes other proximity sensor arrays or other elements, in addition to capacitive, resistive, infrared and surface acoustic wave touch sensing technologies.

According to various embodiments, the touch screen 190 may be arranged on the front surface of the electronic device 100 and include a window, a display, a touch panel, and a pen touch panel.

The window may be transparent, exposed through the front surface of the electronic device 100 and provide an image. The display may include at least one of a liquid crystal display (LCD), an organic light-emitting diode (OLED), an active matrix OLED (AMOLED), a flexible display and a 3D display.

The touch panel may be a transparent switch panel that is stacked on the window. For example, the touch panel may be a capacitive or resistive touch panel for recognizing a data input when a user finger is in direct contact with the surface of the touch screen 190.

Various embodiments, the touch screen 190 may include a touch panel that has a sensor PCB where a plurality of X-axis coil arrays is arranged to be orthogonal to Y-axis coil arrays, and a connector connected electrically to a main board, though not shown. For example, the touch screen 190 may apply an alternating current (AC) signal to a coil formed in a sensing pad so that the sensing pad operates, and if a finger approaches the touch screen 190 to be within a certain distance, it is possible to sense a change in magnetic field formed on the touch screen 190 and grasp a corresponding touch location.

The pen touch panel may be an electromagnetic guidance touch panel that may sense that the touch pen 1 is within a certain distance, before touch pen 1 is in contact with the touch screen 190, or a space touch panel such as a sound wave touch panel or an infrared touch panel.

In the case of the electromagnetic guidance pen touch panel, a plurality of coils may be orthogonally arranged, separately from the touch panel of the electronic device 100. Such a pen touch panel may be called as a digitizer flat panel and include a sensing unit, separately from the touch panel.

The other input/control units 180 may include up/down buttons for controlling volume. In addition, the other input/control units 180 may include at least one of pointer units that include a push button, a locker button, a locker switch, a thumb-wheel, a dial, a stick, and a stylus that have corresponding functions.

The external memory unit 120 may include one or more high speed RAMs such as magnetic disk storage devices or non-volatile memories, or one or more optical storage devices or flash memories (for example, NAND, NOR). The external memory unit 120 stores software which may include an operating system (OS) module, a touch operation module, a communication module, a graphic module, a user interface module, a codec module, a camera module, and one or more application modules. The term module is also represented as a set of instructions, an instruction set, or a program.

The OS module indicates internal OS such as WINDOWS, LINUX, Darwin, RTXC, UNIX, OS X, or VxWorks and may include several software components that control general system operations. The general system operation control may include memory control and management, storage hardware (device) control and management, and power control and management. Moreover, the OS module may also perform a function of making communication between a lot of hardware (devices) and software components (modules) smooth.

In addition to a software component for correcting a touch error that is recognized by a touch panel integrated circuit (IC) and a pen touch panel IC, the touch operation module may include various routines for supporting a touch operation according to the present disclosure. For example, the touch operation module may include a routine for supporting the activation of the touch panel and the pen touch panel and a routine for collecting a hand touch event using a finger and a pen touch event in touch panel and pen touch panel activation operations.

Furthermore, the touch operation module may a routine for supporting the identification of the type of input touch events by checking information corresponding to device information on the touch panel and device information on the touch pen 1 based on a digitizer corresponding to the pen touch panel. Moreover, the touch operation module may include a route for distinguishing the collected user's human-body touch event from the collected pen touch event and a routine for operating the distinguished touch events with reference to a certain touch operation table.

The communication module may enable communication with an opposite electric device such as a computer, a server, and an electronic device, through the wireless communication unit 150 or the external port unit 170.

The graphic module may include several software components for providing and displaying graphics on the touch screen 190. The term graphic may indicate a text, a web page, an icon, a digital image, a video, animation, etc.

The user interface module may include several software components related to a user interface. Moreover, the user interface module may include details such as how the state of the user interface changes, under which condition the state of the user interface changes, etc.

The codec module may include software components related to encoding and decoding video files.

The camera module may include camera related software components that enable camera related processes and functions.

The application module includes browser, email, instant message, word processing, keyboard emulation, address book, contact list, widget, Digital Right Management (DRM), voice recognition, voice copy and position determining functions, and a location based service.

The host unit 110 may further include additional modules (instructions) in addition to the above-described modules. Moreover, the various functions of the electronic device 100 according to the present disclosure may be executed in hardware that includes one or more stream processing or application specific integrated circuits (ASICs), or in software.

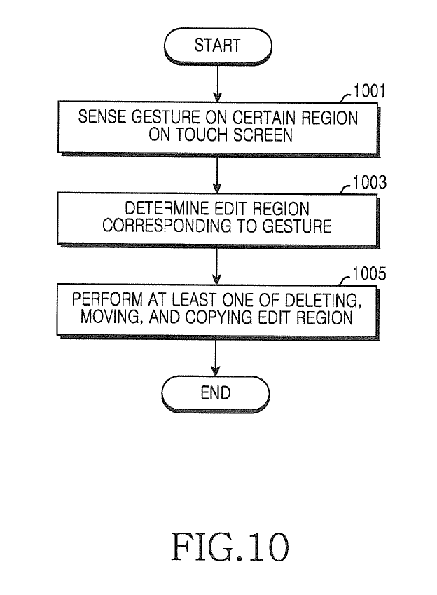

FIG. 10 is a flowchart illustrating a screen editing method according to an embodiment of the present disclosure.

Referring to FIG. 10, in operation 1001, the electronic device 100 may sense a gesture on a certain region of the touch screen 190. The gesture may include performing any one of flicking, touching & dragging, tab & hold, and multiple tab operations on the touch screen 190. For example, the gesture may be the operation of drawing a region setting mark such as a reference line or a parenthesis on the touch screen 190.

The electronic device 100 may be a device such as a mobile phone, a media player, a tablet computer, a handheld computer or a PDA. Moreover, the electronic device 100 may be any portable terminal that includes a device having the functions of two or more of these devices.

Next, in operation 1003, it is possible to determine an edit region corresponding to the gesture. The edit region may be at least one of a first handwriting type region input in a handwriting type input mode and a region between the first handwriting type region and a second handwriting type region. In some cases, the edit region may be an empty region that has no data.

Next, in operation 1005, it is possible to perform at least one of deleting, moving, and copying the edit region. Here, the operation of performing at least one of deleting, moving, and copying the edit region may be confirmed by using a popup window that contains at least one of text, image and voice data. If the edit region has no data, it is possible to delete the edit region without confirmation. In addition to the deleting, moving, and copying the edit region, various edit functions may be performed.

Subsequently, the procedure of the present disclosure ends.

A set of instructions for these operations may be stored as one or more modules in the memory. In this case, the modules stored in the memory may be executed by the one or more processors 112.

Before describing the following various embodiments, it should be noted that some detailed descriptions may be skipped since the following section includes components similar to those that are already described above.

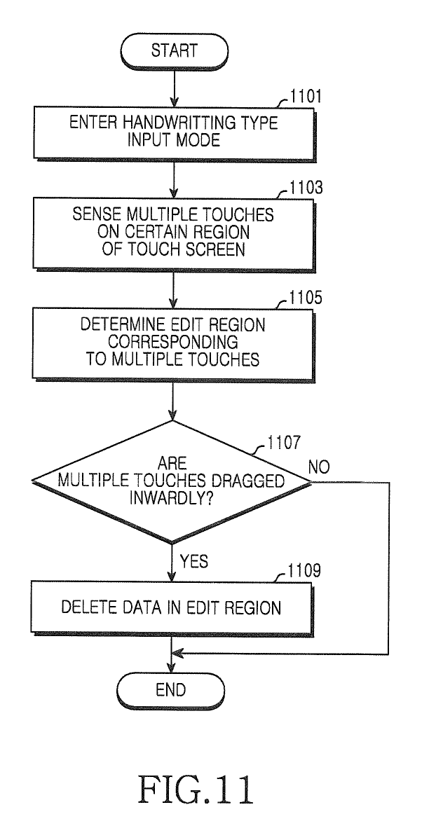

FIG. 11 is a flowchart illustrating a screen editing method according to an embodiment of the present disclosure.

Referring to FIG. 11, in operation 1101, the electronic device 100 may enter a handwriting type input mode. The handwriting type input mode may appear when an application that may input handwriting is executed. In this case, the electronic device 100 may sense a gesture. Here, the gesture may mean a series of operations that includes dragging while maintaining a touch, and a touch release.

Next, in operation 1103, it is possible to sense multiple touches on a certain region of the touch screen 190. As shown in FIG. 2B, it is possible to two different touch points, and in some cases, it is also possible to three or more different touch points.

Next, in operation 1105, it is possible to determine an edit region corresponding to the multiple touches. As shown in FIG. 2B, if a user touches the touch screen 200 for a certain time (for example, two seconds), a first guide line 210 may appear in a horizontal direction around a touch point recognized by the thumb 2, and a second guide line 220 may appear in a horizontal direction around a touch point recognized by the forefinger 3. Moreover, the edit region 240 may be determined by using the first guide line 210 and the second guide line 220.

According to various embodiments, the guide lines may also become vertical guide lines depending on the touch locations of the fingers. For example, when the slope of a line formed by connecting the touch location of the thumb to the touch location of the forefinger is detected and the slope is equal to or greater than a certain angle from a horizontal line, the guide lines may become vertical guide lines.

Next, in operation 1107, it is possible to determine whether multiple touches are dragged inwardly. As shown in FIG. 2B, the electronic device 100 may sense whether dragging is performed inwardly by a certain distance (for example, 5 mm) while maintaining a touch.

Next, in operation 1109, it is possible to delete data from the edit region. Here, the data may be characters, numerals, special symbols, and special characters, and may be image-type data. The data in the edit region may be simultaneously deleted and a popup window to check whether to delete may be displayed.

Subsequently, the procedure of the present disclosure ends.

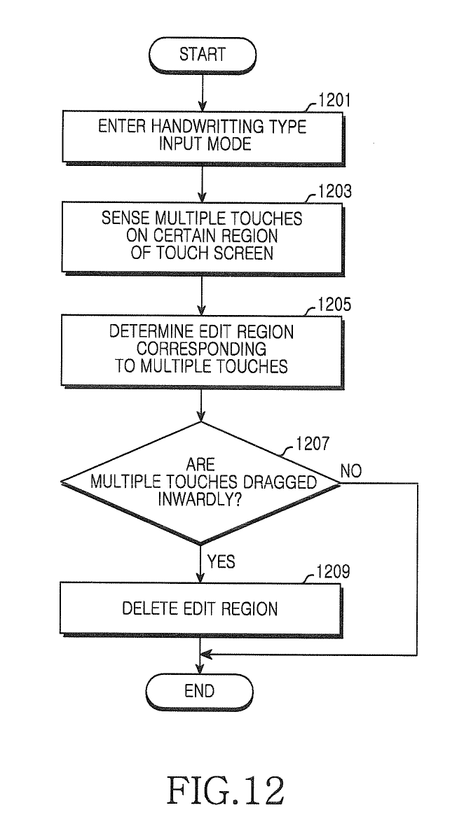

FIG. 12 is a flowchart illustrating a screen editing method according to an embodiment of the present disclosure.

Referring to FIG. 12, in operation 1201, the electronic device 100 may enter a handwriting type input mode. The handwriting type input mode may appear when an application that may input handwriting is executed. In this case, the electronic device 100 may sense a gesture. Here, the gesture may mean a series of operations that includes dragging while maintaining a touch, and a touch release.

Next, in operation 1203, it is possible to sense multiple touches on a certain region of the touch screen 190. As shown in FIG. 3B, it is possible to two different touch points, and in some cases, it is also possible to three or more different touch points.

Next, in operation 1205, it is possible to determine an edit region corresponding to the multiple touches. As shown in FIG. 3B, if a user touches the touch screen 300 for a certain time, a first guide line 340 may appear in a horizontal direction around a touch point recognized by the thumb 2, and a second guide line 350 may appear in a horizontal direction around a touch point recognized by the forefinger 3. Moreover, the edit region 360 may be determined by using the first guide line 340 and the second guide line 350.

According to various embodiments, the guide lines may also become vertical guide lines depending on the touch locations of the fingers. For example, when the slope of a line formed by connecting the touch location of the thumb to the touch location of the forefinger is detected and the slope is equal to or greater than a certain angle from a horizontal line, the guide lines may become vertical guide lines.

Next, in operation 1207, it is possible to determine whether multiple touches are dragged inwardly. As shown in FIG. 3B, the electronic device 100 may sense whether dragging is performed inwardly by a certain distance while maintaining a touch.

Next, in operation 1209, it is possible to delete the edit region. In this case, a popup window to determine whether to delete the edit region may be displayed. Various embodiments, as shown in FIG. 3C, if the edit region is deleted, the upper region 310 is connected to the lower region 330 and an empty region 370 may be further arranged at the lower end of the touch screen 300.

Subsequently, the procedure of the present disclosure ends.

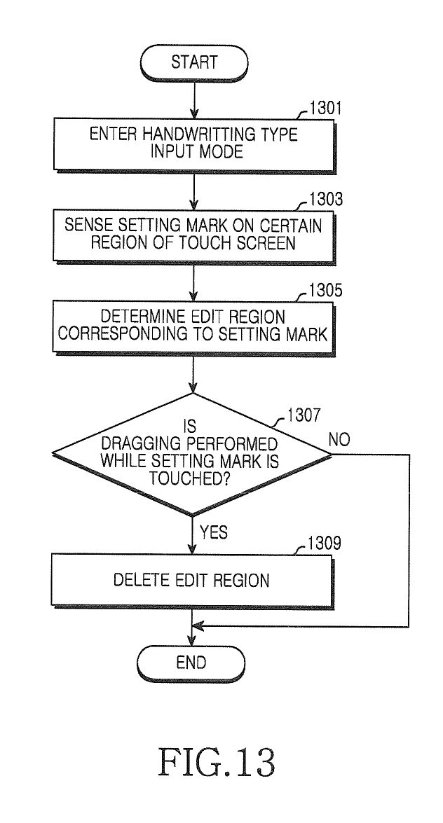

FIG. 13 is a flowchart illustrating a screen editing method according to an embodiment of the present disclosure.

Referring to FIG. 13, in operation 1301, the electronic device 100 may enter a handwriting type input mode. The handwriting type input mode may appear when an application that may input handwriting is executed. In this case, the electronic device 100 may sense a gesture. Here, the gesture may mean a series of operations that includes dragging while maintaining a touch, and a touch release.

Next, in operation 1303, it is possible to sense a region setting mark on a certain region of the touch screen 190. The region setting mark may be a region binding mark 430 such as a parenthesis “]” or “}” as shown in FIG. 4A.

Next, in operation 1305, it is possible to determine an edit region corresponding to the setting mark.

As shown in FIG. 4A, it is possible to select an edit region 460 corresponding to the region setting mark 430 such as a parenthesis.

Next, in operation 1307, it is possible to determine whether the setting mark is dragged while maintaining a touch. As shown in FIG. 4B, it is possible to determine whether the region setting mark 430 is dragged from a certain region to a second certain region while maintaining a touch.

Next, in operation 1309, it is possible to delete the edit region. In this case, a popup window to determine whether to delete the edit region may be displayed. Various embodiments, as shown in FIG. 4C, if the edit region is deleted, the upper region 410 may be connected to the lower region 430 and an empty region 470 may be further arranged at the lower end of the touch screen 400.

Subsequently, the procedure of the present disclosure ends.

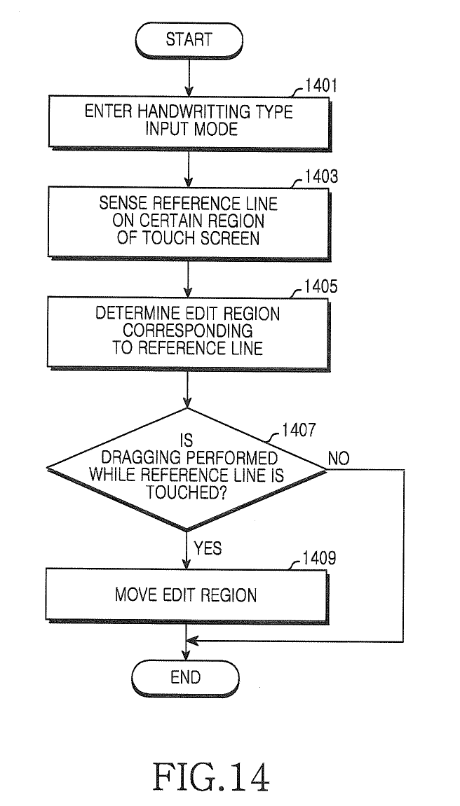

FIG. 14 is a flowchart illustrating a screen editing method according to an embodiment of the present disclosure.

Referring to FIG. 14, in operation 1401, the electronic device 100 may enter a handwriting type input mode. The handwriting type input mode may appear when an application that may input handwriting is executed. In this case, the electronic device 100 may sense a gesture. Here, the gesture may mean a series of operations that includes dragging while maintaining a touch, and a touch release.

Next, in operation 1403, it is possible to sense a reference line on a certain region of the touch screen 190. As shown in FIG. 5A, the reference line 510 may be a horizontal line and if the line has a certain length, the line may be recognized as the reference line 510.

Next, in operation 1405, it is possible to determine an edit region corresponding to the reference line. As shown in FIG. 5A, it is possible to determine an edit region corresponding to a lower part of the touch screen 500 from an extension line extended in a length direction of the reference line 510.

Next, in operation 1407, it is possible to determine whether the reference line is dragged while maintaining a touch. As shown in FIG. 5B, it is possible to measure a distance h dragged up or down while touching the reference line 510.

Next, in operation 1409, it is possible to move the edit region. As shown in FIG. 5C, the edit region 520 may move up by the distance h that the reference line 510 is dragged. Moreover, a popup window to check whether to move the edit region may be displayed. Various embodiments, the edit region 520 may be connected to the upper region 530, and since the edit region 520 moves by the distance h, the empty region 540 may be further arranged under the edit region 520.

Subsequently, the procedure of the present disclosure ends.

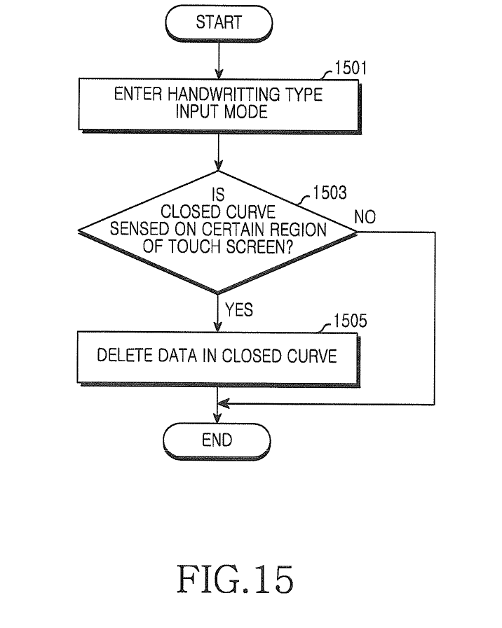

FIG. 15 is a flowchart illustrating a screen editing method according to an embodiment of the present disclosure.

Referring to FIG. 15, in operation 1501, the electronic device 100 may enter a handwriting type input mode. The handwriting type input mode may appear when an application that may input handwriting is executed. In this case, the electronic device 100 may sense a gesture. Here, the gesture may mean a series of operations that includes dragging while maintaining a touch, and a touch release.

Next, in operation 1503, it is possible to determine whether a closed curve is sensed on a certain region of the touch screen 190. If a closed curve 610 of a certain size is drawn in an eraser mode as shown in FIG. 6A, it may be recognized that a user has an intention to delete a corresponding region.

Next, in operation 1505, it is possible to delete data that is included in the closed curve. As shown in FIG. 6B, it is possible to delete the data 620 from the inside of the closed curve 610 and it is possible to display a popup window to check whether to delete the data 620.

Various embodiments, if a diagonal line 630 is drawn in the closed curve 610 as shown in FIG. 6C after deleting the data 620, it is possible to delete the edit region 650 corresponding to the closed curve 610. The lower region 660 of the touch screen 600 may be connected to the upper region 640 and the empty region 670 may be further arranged at the lower end of the touch screen 600 (as illustrated, for example, in FIG. 6D).

Subsequently, the procedure of the present disclosure ends.

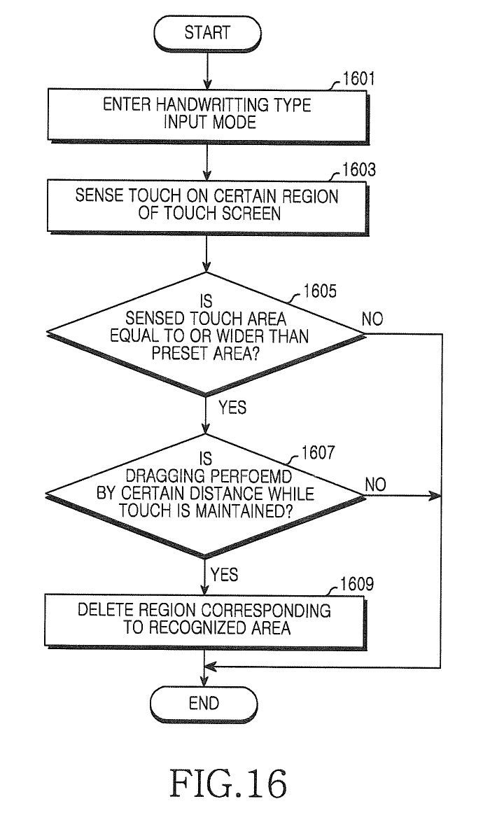

FIG. 16 is a flowchart illustrating a screen editing method according to an embodiment of the present disclosure.

Referring to FIG. 16, in operation 1601, the electronic device 100 may enter a handwriting type input mode. The handwriting type input mode may appear when an application that may input handwriting is executed. In this case, the electronic device 100 may sense a gesture. Here, the gesture may mean a series of operations that includes dragging while maintaining a touch, and a touch release.

Next, in operation 1603, it is possible to sense a touch on a certain region of the touch screen 190. In the case of an eraser mode, it is possible to sense at least a part of a finger on the touch screen 190.

Next, in operation 1605, it is possible to determine whether a sensed touch area is equal to or wider than a preset area. As shown in FIG. 7A, if the area of an region 710 touched by at least a part of a finger on a certain region of the touch screen 190 is wider than a preset area, it may be recognized that a user has an intention to delete a corresponding region.

Next, in operation 1607, it is possible to determine whether dragging is performed by a certain distance while maintaining a touch. As shown in FIG. 7A, it is possible to sense whether the at least a part of a finger moves from a certain region to a second region while the at least a part of a finger is touched.

Next, in operation 1609, it is possible to delete a part corresponding to a recognized area. Various embodiments, as shown in FIG. 7B, it is possible to select and delete the edit region 730 corresponding to the area recognized by dragging and as shown in FIG. 7C, the lower region 740 of the touch screen 700 may be connected to the upper region 720 and the empty region 750 that corresponds to the area of the edit region 730 deleted may be further arranged under the lower region 740.

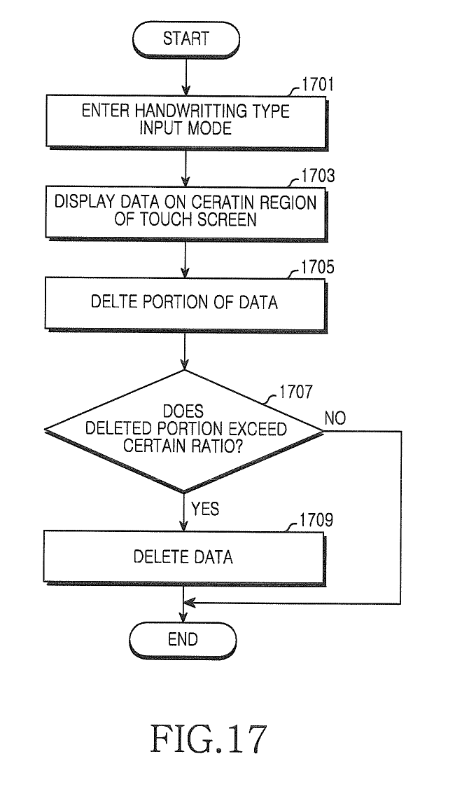

FIG. 17 is a flowchart illustrating a screen editing method according to an embodiment of the present disclosure.

Referring to FIG. 17, in operation 1701, the electronic device 100 may enter a handwriting type input mode. The handwriting type input mode may appear when an application that may input handwriting is executed. In this case, the electronic device 100 may sense a gesture. Here, the gesture may mean a series of operations that includes dragging while maintaining a touch, and a touch release.

Next, in operation 1703, it is possible to display data on a certain region of the touch screen 190. As shown in FIG. 8A, a user may draw characters, numbers, special symbols, and special characters by touching & dragging the touch screen 190.

Next, in operation 1705, it is possible to delete a portion of data. In an eraser mode, it is possible to delete a portion 820 of data 810.

Next, in operation 1707, it is possible to determine whether the deleted portion 820 of the data exceeds a certain ratio. As shown in FIG. 8C, it is possible to detect the area 840 of the deleted portion 820 of the data 810 and compare it with a reference area. For example, if a ratio of the area 840 of the at least the deleted portion 820 of the data 810 to the entire recognition area 820 of the data 810 is equal to or greater than a certain ratio, it may be determined that a user has an intention to delete a corresponding region.

Next, in operation 1709, it is possible to delete data.

Subsequently, the procedure of the present disclosure ends.

According to various embodiments of the present disclosure, each module may be configured in software, in firmware, in hardware, or as a combination thereof. Moreover, some or all modules may be configured in one entity and equally perform the function of each module. According to various embodiments of the present disclosure, each operation may be performed sequentially, repetitively, or in parallel. Moreover, some operations may be skipped or other operations may be added. For example, each operation may be performed by a corresponding module described in the present disclosure.

Moreover, methods according to embodiments described in the following claims or the specification of the present disclosure may be implemented in hardware, in software or as a combination thereof.

When the methods are implemented in software, a computer readable recording medium that stores one or more programs (software modules) may be provided. One or more programs stored in the computer readable recording medium are configured to be able to be executed by one or more processors in the electronic device. One or more programs include instructions that allow the electronic device to execute the methods according to the embodiments described in the claims and/or the specification of the present disclosure.

Such programs (software modules or software) may be stored in random access memories (RAMs), non-volatile memories including flash memories, read only memories (ROM), Electrically Erasable Programmable Read Only Memories (EEPROMs), magnetic disc storage devices, Compact Disc-ROMs (CD-ROMs), Digital Versatile Discs (DVDs), other types of optical storage devices, or magnetic cassette. Alternatively, the programs may be stored in a memory that consists of a combination of some or all thereof. Moreover, each component memory may be included in plural.

Moreover, the programs may be stored in an attachable storage device that may access the electronic device through a communication network such as Internet, intranet, LAN, WLAN, or SAN, or a communication network that is configured as a combination thereof. Such a storage device may access the electronic device through an external port.

Moreover, a separate storage device on a communication network may also access a portable electronic device.

While particular embodiments have been described in the detailed description of the present disclosure, several variations may be made without departing from the scope of the present disclosure. Therefore, the scope of the present disclosure should not be limited to the above-described embodiments but be defined by the following claims and equivalents thereof.

What is claimed is:

1. A method of operating an electronic device, the method comprising:
sensing a gesture on a certain region of a touch screen;
determining an edit region corresponding to the sensed gesture; and
editing at least one of a first region input in a handwriting type input mode or a region between the first region and a second region in the edit region.

2. The method of claim 1, wherein the gesture indicates that at least a part of a finger or a touch pen performs any one of a flicking, a touch and drag, a tab and hold, and multiple tab operations on the touch screen.

3. The method of claim 1, wherein the gesture comprises drawing a region binding symbol such as a reference line or a parenthesis on the touch screen.

4. The method of claim 1, wherein the sensing of the gesture on the certain region of the touch screen is performed in an eraser mode.

5. The method of claim 1, wherein the sensing of the gesture on the certain region of the touch screen is determined by using a closed curve made to have a certain size.

6. The method of claim 5, further comprising deleting a region made by the closed curve if a diagonal line is drawn in the closed curve.

7. The method of claim 1, wherein the editing of the edit region is performed by confirmation through a popup window that contains at least one of a text, an image, and voice data.

8. The method of claim 1, further comprising automatically deleting the edit region if the edit region has no data.

9. The method of claim 1, wherein:
sensing the gesture comprises sensing multiple touches on the certain region of the touch screen;
determining the edit region comprises determining the edit region corresponding to the sensed multiple touches; and
the method further comprises editing the edit region or data in the edit region according to a dragged direction in response to the multiple touches being dragged.

10. The method of claim 9, wherein editing the data comprises deleting data in the edit region or expanding the edit region according to the dragged direction.

11. The method of claim 9, wherein editing the data comprises expanding or reducing a size of data in the edit region according to the dragged direction.

12. The method of claim 1, wherein:
sensing the gesture comprises sensing a reference line on a certain region of the touch screen;
determining the edit region comprises determining the edit region corresponding to the sensed reference line; and
the method further comprises editing the edit region or data in the edit region according to a dragged direction in response to the reference line being dragged.

13. The method of claim 12, wherein editing the data comprises deleting data in the edit region or expanding the edit region according to the dragged direction.

14. The method of claim 12, wherein editing the data comprises expanding or reducing a size of data in the edit region according to the dragged direction.

15. An electronic device comprising:
a touch screen configured to sense a gesture; and
a processor operably connected to the touch screen, wherein the processor is configured to determine an edit region corresponding to the gesture, instruct to edit the determined edit region, and edit at least one of a first region input in a handwriting type input mode or a region between the first region and a second region in the edit region.

16. An electronic device comprising:
a touch screen configured to sense multiple touches; and
a processor operably connected to the touch screen, wherein the processor is configured to enter a handwriting type input mode, determine an edit region corresponding to the multiple touches, and instruct to edit the edit region or data in the edit region according to a dragged direction in response to the multiple touches being dragged.

17. The electronic device of claim 16, wherein the processor is configured to instruct to delete data in the edit region or expand the edit region.

18. The electronic device of claim 16, wherein the processor comprises a control unit configured to delete the edit region and data in the edit region or expand the edit region.

19. The electronic device of claim 16, wherein the processor comprises a control unit configured to expand or reduce a size of data in the edit region.

20. An electronic device comprising:
a touch screen configured to sense a reference line; and
a processor operably connected to the touch screen, wherein the processor is configured to enter a handwriting type input mode, determine an edit region corresponding to the reference line, and instruct to edit the edit region or data in the edit region according to a dragged direction in response to the reference line being dragged.
